(19) United States
(12) Patent Application Publication
(10) Pub. No.: US 2003/0210806 A1
(43) Pub. Date: Nov. 13, 2003

(54) Navigational information service with image capturing and sharing

(75) Inventors: Shintani Yoichi, Palo Alto, CA (US); Kohiyama Tomohisa, Sunnyvale, CA (US); Naemura Makiko, Palo Alto, CA (US)

Correspondence Address: David T. Cunningham. Esq., Hitachi America, Ltd., 50 Prospect Avenue, Tarrytown, NY, 10591, US

(73) Assignee: Hitachi, Ltd., Tokyo (JP)

(21) Appl. No.: 10/141,452

(22) Filed: May 7, 2002

(51) Int. Cl. G06K 9/00

(52) U.S. Cl. 382/104

(57) ABSTRACT

A plurality of vehicles with cameras and other sensors collect images and other data as a normal event, or upon demand, or when requested to do so by another vehicle, an occupant or a service center. Images may be permanently stored in the vehicles and indexed in a directory at a service center, so that the images may selectively sent to the service center or another vehicle without consuming storage space at the service center. When the service center is managing sufficient current data for an area, the service center generates a suspension signal to discard or instruct vehicles not to send further images from that area.

### FIELD OF THE INVENTION

The present invention relates to the capturing of video images by vehicle cameras, the storage of such images and the use of such images.

### BACKGROUND OF THE INVENTION

To add to the comfort and safety of the driver of a vehicle, it is very useful to provide drivers with information about conditions along the driving route, such as, traffic and weather. To generate and distribute accurate information for any driver, anywhere and anytime, it is needed to gather a huge volume of primitive data.

Because each unit of data represents traffic and weather conditions at a specific location and at a specific point in time, an accurate service that provides data for many locations, must handle a large amount of the data. If the data is not timely, it is of little use. To assure the time coverage and the geographic coverage is as broad as possible, a comprehensive sensing system to gather the primitive data is necessary.

While safe driving has been a major concern for a long time, the need for such seems to be increasing despite many prior art attempts at solutions.

Therefore, there is a long felt need to increase the coverage and efficiency of image monitoring for navigation and safety. A further need is to decrease the cost of such monitoring. These two needs appear to involve conflicting solutions, each solution appears to help one need at the expense of the other need.

Vehicle mounted cameras capture image data for various purposes, as shown by the prior art, but such prior art does not fully satisfy the needs as set forth above.

Safety and Accidents: The U.S. Pat. No. 6,246,933 B1 to Bague, dated Jun. 12, 2001, discloses a vehicle-mounted digital video/audio camera system that includes a plurality of sensors for sensing, storing and updating operation parameters, visual conditions and audible conditions; the data is read so that an accident involving the automobile may be reconstructed. A different known system processes 3-D images and other data to provide a collision alert to the driver of a vehicle. Patent application No. US 2002/0009978 A1 to Dukach et al, dated Jan. 24, 2002, broadcasts images from a mobile unit's cameras to help record what is happening in an emergency signaled by the driver and to determine criminal fault.

Weather monitoring: U.S. Pat. No. 6,208,938 B1 to Doerfel, dated Mar. 27, 2001, discloses weather monitoring with unattended high-resolution digital cameras and laser rangers at one local region, such as an airport.

Guidance assistance: U.S. Pat. No. 6,067,111 to Hahn et al, dated May 23, 2000, discloses a video camera mounted on the top of a vehicle for acquiring images to the front of the vehicle. U.S. Pat. No. 5,850,254 to Takano et al, dated Dec. 15, 1998, mounts a video camera inside of a vehicle to view the area in front of the vehicle to assist the driver in guiding the vehicle, with compensation for camera vibrations.

Scenery record: U.S. Pat. No. 5,961,571 to Gorr et al, dated Oct. 5, 1999, stores only selected image data representing successive panoramic views of scenery about a vehicle, as long as the vehicle stays on a pre-established route.

Pavement inspection: U.S. Pat. No. 4,958,306 to Powell, dated Sep. 18, 1990, uses an image to determine an elevation profile or surface distress for pavement inspection.

Object recognition: U.S. Pat. No. 5,638,116 to Shimoura et al, dated Jun. 10, 1997, inputs images to an object recognition system, e.g. to recognize road signs. In U.S. Pat. No. 5,850,254, to Takano et al, Dec. 15, 1998, a vehicle reference mark fixed to the vehicle is within an image pickup area, to be compared to subsequent images.

Map generation: U.S. Pat. No. 5,948,042 to Helmann et al, dated Sep. 7, 1999, image data taken from test vehicles is transmitted to a central location at night, where the data is used to update an existing digital road map, which map is used in traffic directing and guiding vehicles to their destination.

Japan Application Number 09188728, Publication number 11031295, published Feb. 2, 19990, to Satoshi et al discloses a vehicle camera and GPS to radio transmit information to a control center, which recognizes a traffic Jam, traffic control and weather, for inclusion on a map based on position information.

Navigation: According to the Patent Abstracts of Japan, Japanese patent application Publication number 11-205782 to Nojima Akihiko, dated Jul. 30, 1999, exterior and interior vehicle images are sent to a station so that various kinds of conversation, such as route guiding, can be executed, based on the shared image. U.S. patent application No. 2001/0052861 A1 to Ohmura et al, dated Dec. 20, 2001, has an onboard navigational unit that sends map images of an area around a current position of an automobile to an onboard display unit visible to the driver; a map includes a symbol to identify the current position; the data format also allows reproduction on a personal computer. In Japan Application Number H10-1337, Release Number H11-205782, dated Jul. 30, 1999, forward images from vehicles are sharing between a navigation system and a service station.

According to the Japanese patent application by Hashimoto Satoshi of TOSHIBA CORP, Publication Number 11031295A, entitled “ROAD INFORMATION MANAGEMENT SYSTEM AND ROAD INFORMATION TERMINAL EQUIPMENT”, a road information management center receives and stores picture and location information wireless transmitted from fixed point watching apparatus and mobile watching apparatus. The road information management center generates information expressing the condition of the road by analyzing the stored picture information and location information. The mobile picture information is taken by many business use vehicles, while driving or parked, such as a home delivery service company, a cab company and a delivery company. The many existing business vehicles provide a low-price system for collecting information, as compared with the system using many fixed observation points. Map information is displayed on a liquid crystal screen of a user's mobile terminal. The user of the mobile terminal may be from the general public or a business. The user requests road information of a desired road section by reference to the display map. The mobile terminal sends a display request to an on-board apparatus. The on-board apparatus reads map information corresponding to the request from a memory, and downloads it to the mobile terminal.

Traffic monitoring: U.S. Pat. No. 5,164,904 to Sumner, dated Nov. 17, 1992, provides real-time traffic congestion data (text, voice and map displays) to drivers of vehicles from a central location where information from a range of sources is accumulated and aggregated into a single congestion level data value for each section of road.

Advertising: U.S. patent application No. 2002/0009978 A1 to Dukach et al, dated Jan. 24, 2002, uses a video display on the outside of a commercial vehicle as a billboard to display advertisements to the public. In addition, to create audience interest, a live image (still or video) of the audience or surroundings is displayed.

Weather and traffic: US 2002/0009978 A1 to Dukach et al, dated Jan. 24, 2002, while primarily relating to advertising and discussing many options and embodiments, captures traffic and weather video images from mobile commercial vehicles and transmits them to a central location. A mobile unit can make a show-me request of a specific location to the central unit, which will then take a picture indirectly through the central system, presumably to be displayed outside the vehicle to develop audience interest. Images may be identified at the central location as to vehicle identity, time, place and vehicle speed. Images may be stored in a traffic database that enables drivers of the system's mobile units to find more effective routes at various times and places, and provides media content, which can be sold by the central system to be used to attract audiences to a website, or which can be displayed on the outdoor displays of the system. Visual recognition systems estimate weather conditions and record conditions in a database associated with the time and location in which such images were recorded, and in addition visual images of the weather can be stored in this database, which information can be used to help drivers of the system's mobile units, sold or licensed by the central system. For taxis, the central system can use the input to calculate one or more of the best routes to a destination, considering factors of location, time, current traffic-information and history of traffic at similar times, and then the central system transmits one or more of such routes to the cab for display to the driver. The mobile units obtain and upload to a central system information they sense about the weather in their own local, and then receive information back from the central system about weather over a larger geographic area which they then display on their external displays.

Police monitoring: U.S. Pat. No. 6,262,764 B1 to Peterson, dated Jul. 17, 2001, has a VCR in a closed vault for recording images from cameras located about the police vehicle and on a clipboard, and provides wireless communication with a police station.

Vehicle Cameras: According to the Patent Abstracts of Japan, Japanese patent application Publication-257920 to Okamoto Satoru, dated Sep. 21, 2001, a vehicle mounted camera can be programmed to take pictures at stored locations from a desired angle upon reaching the location as determined by a GPS system.

### SUMMARY OF THE INVENTION

The present invention increases the coverage and efficiency of image monitoring for navigation as well as for security and safety. A further need is to decrease the cost of such monitoring.

As parts of the present invention, the inventors have analyzed the prior art to determine problems relating to vehicle navigation, security, emergencies and safety, and identified causes of these problems to provide solutions to the problems as implemented by the embodiments.

One prior art approach to gathering primitive image data is to install fixed sensing facilities at various places along a road. With this approach, the initial installation and maintenance cost is huge to cover all the roads across the nation. There are places and roads where even electricity may not be available. It is not cost effective to place such equipment on roads where the traffic is extremely low.

Another prior art approach is to have vehicles carry data sensors and transmit the captured primitive data to a central location. Accordingly, the land-fixed sensing facility cost across the nation is not needed. However, the vehicles are usually business vehicles with limited special purpose routes, which severely limits coverage. If more vehicles are involved, the cost goes up in relationship to a small gain in coverage, and there is no incentive to increase the number of vehicles involved. Furthermore as the number of data collecting vehicles increases, so does the volume of data collected increase. The volume of data becomes huge, stressing the bandwidth of the transmission to a central location.

At the prior art central location that receives the primitive data, the data is analyzed, combined and condensed as to weather and traffic conditions. With such systems, it is common to find that the analysis result or summary is quite old and the conditions have already changed, the receiving driver is not sure how old the data is upon which the analysis was done, and the driver is not sure of the location where the data was captured. That is, the prior art weather and traffic condition data summaries and analysis transmitted to a driver are not reliable.

The Satoshi publication requires that all information sent to a user must be analyzed, processed and stored at a central location. This requires a large storage and processing ability at the central location. Of necessity, the data is condensed to result in loss of meaning, the data is from widely spaced points to diminish its usefulness, and the data is averaged with resulting loss of accuracy. The amount of processing would at times overload the system and render the data stale.

The present embodiment enables efficient and up-to-date visual presentation of requested information, which can supplement audio and text presentations.

A solution, provided by the present invention, is for vehicles to carry appropriate sensors, including video cameras and microphones, and communication measures to capture the primitive environmental data while driving and transmit the data to where the data is needed or is safely stored until needed.

According to this invention, there is no need for costly land-fixed sensing facilities across the nation.

According to the embodiment, vehicles are equipped with one or more digital cameras, various sensors, a computer, user interface, and broadband wireless data communication with central locations and directly or indirectly with other vehicles for a peer-to-peer transfer of large up-to-date video files.

The cameras capture front-road views upon the occurrence of certain events, for example, for each half-mile driven, when the vehicle makes a turn, when the vehicle detects a predetermined object, or when the driver and/or a passenger thinks it desirable to do so. One or more service centers store data captured and sent from the digital cameras and provide various new services based upon the data. A driver can check the traffic situation all the way to the destination by accessing images captured by cameras on other vehicles that have driven the same route. There is more than one camera in each vehicle system, so that each vehicle captures front, rear and side views. Also the cameras capture images while the vehicle is parked and upon request.

When an image is captured, associated information is logically or physically attached to the image. Such information includes date and time the image was taken, location where the image was taken and a profile of the owner of the vehicle who took the image (for example, an owner ID), etc. A packet of information, including the image and the attached information is called a primitive data packet. Primitive data packets are stored temporarily or permanently in vehicle and are transmitted to the service center for permanent storage or retransmission to another driver using broadband wireless data communication

The data, including image and associated information, is used, for example, to know the current traffic and road situation before the requesting vehicle approaches a location, so that the requestor can evaluate the condition of the route around and to the location. Navigational information, such as images of remarkable signs, buildings and scenery along the driving route, is a part of the data. The service center organizes, stores and analyzes the data. The organized data is used by the central service center to assess current road traffic and make assessments available to the drivers; for example, the data is analyzed to extract statistical information about the traffic on each road. As requested from the service center, the users get exact data, or as appropriate, abstracted information. For example, a driver can access images that were taken only within the last 10 minutes and sort them geographically by mileage post of the highway along a planned driving route.

The images are useful to keep as a driving record for each driver and to plan the next drive.

The embodiment functions as a stand-alone new generation navigational system or enhances of an existing system.

A driver or the like may access an Internet web site of the service center through a PC connected to the internet, before driving or through a vehicle computer system while sitting in the vehicle. The service center transmits or arranges for another vehicle to transmit recent or real-time images from close to the location.

Image icons are on the map where stored images were taken. The driver chooses the most appropriate icon by point and click. The image is displayed to the requestor together with the speed and direction of the vehicle that had captured the image; at the same time, the associated data, such as the temperature, is displayed. By presenting the recent images and the associated information, the driver can intuitively perceive and evaluate road and weather conditions.

There are two ways to exchange the images, for the purpose of regional, nationwide and global sharing of the data. One way is from the service center storage. The other way is from storage in other vehicles, by direct or indirect communication, to avoid delays that cause stagnation of the data and to lessen the storage and processing load on the service center. A driver or other requestor obtains images and associated information that reside in other vehicles through peer-to-peer communication between vehicles. As an alternative to receiving the data from the service center storage or in the event that the service center is not able to present desired information to the requesting driver or as a requestors option, the driver can further command their vehicle system or the service center to search for the desired data from other vehicles. When the data is found stored in another vehicle, the data is transmitted directly or indirectly through the service center from the other vehicle to the requestor, using a peer-to-peer function.

Once the peer-to-peer function is invoked, the vehicle system or the service center will send the request to all or a limited number of vehicles that are equipped according to this embodiment. The request may also be limited to a location range (distance that the image was captured from a specific location) or limited to a time of capture range (age range of the images, or elapsed time between image capture and request time). The range is automatically set (for example, the range is expanded if the amount of data is small or not available for the initial range), set according to the service paid for by the requestor, or set as a requestor's option. When another vehicle has the requested data in storage, then it transmits the data to the requesting vehicle, where the data is displayed in the same way as the display of the data obtained from storage at the service center, or displayed differently depending upon the purpose of the request.

To facilitate and standardize the sharing of data, the data is most preferably stored and presented using web services technology. For example, transmission uses the IEEE 802.11 a/b standard, or a data communication service (for example a cellular phone), a broadband wireless LAN of a service provider, or any local host or private wireless units, all using well known technology. By using Web Services technology, the data is accessed and presented through a web browser and handled by well-known browser software for further processing.

Still other aspects, features, and advantages of the present invention are readily apparent from the following detailed description, simply by illustrating a number of particular embodiments and implementations, including the best mode contemplated by the inventor for carrying out the present invention. The present invention is also capable of other and different embodiments, and its several details can be modified in various obvious respects, all without departing from the spirit and scope of the present invention. Accordingly, the drawing and description are to be regarded as illustrative in nature and not as restrictive.

### BRIEF DESCRIPTION OF THE DRAWINGS

The present invention is illustrated by way of example, and not by way of limitation, in the figures of the accompanying drawing, in which like reference numerals refer to similar elements, and in which:

FIG. 1 is a schematic diagram of an embodiment of the overall system equipment to practice the present invention;

FIG. 2 is a flow chart of the method of the embodiment as practiced by one vehicle interacting with the other components of the overall system of FIG. 1, upon the occurrence of different events;

FIG. 3 is a flow chart of the method of operation of one of the functionally like service centers interacting with the other components of the overall system of FIG. 1;

FIG. 4 shows the step 320 of FIG. 3, in more detail;

FIG. 5 shows the step 450 of FIG. 4, in more detail;

FIG. 6 is a schematic representation of a computer screen display for a vehicle computer or laptop practicing the method of FIG. 2, more particularly showing a representative map display of step 205 of FIG. 2 and representative display of step 803 of FIG. 8;

FIG. 7 is a schematic representation of a computer screen display for a vehicle computer or laptop practicing the method of FIG. 2, more particularly showing a representative image display of step 270 with data from steps 260 and 265 of FIG. 2 and a representative image display of step 808 and 810 of FIG. 8;

FIG. 8 is a flow chart of the method of the embodiment for the system operation, with a vehicle requesting an image taken at a specific location, in more detail than provided by steps 260, 265 and 270 of FIG. 2;

FIG. 9 is a flowchart of the operation of the overall system in managing the storage of a captured image, particularly with respect to the image flag, which operation includes steps 230 and 235 of FIG. 2;

FIG. 10 shows what an actual map display according to FIG. 6 would look like, with the curser positioned to choose a location on the map;

FIG. 11 shows what an actual image display according to FIG. 7 would look like as taken from the location chosen in FIG. 10;

FIG. 12 shows a map display similar to FIG. 10, but with the curser positioned further along the highway; and

FIG. 13 shows an actual image display similar to FIG. 11, but for the location choice of FIG. 12.

FIG. 14 is a flowchart of the portion of the embodiment method relating to a vehicle sensing an emergency or an occupant of the vehicle declaring an emergency to capture a video history of the event; and

FIG. 15 is a flowchart of the portion of the embodiment method relating to a vehicle sensing an emergency originating with another vehicle or an occupant of the vehicle declaring an emergency to capture a video history of the event.

### DESCRIPTION OF THE PREFERRED EMBODIMENT

The system, architecture, and business method function as a new navigational system, or as an enhancement of a prior art system.

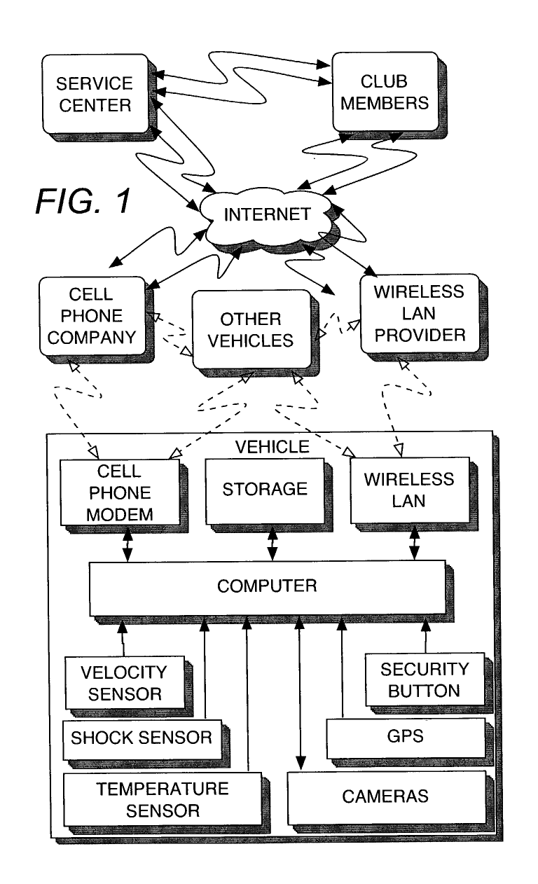

In FIG. 1, a plurality of vehicles (VEHICLE and OTHER VEHICLES) are in direct vehicle to vehicle wireless communication with each other, for example over a radio frequency band. The vehicles are also each in wireless LAN communication with a WIRELESS LAN PROVIDER through which they may communicate with each other, and in wireless cell phone communication with a CELL PHONE COMPANY through which they may communicate with each other. This wireless communication is two-way, including receiving and transmitting, which may be according to well-known technology.

The CELL PHONE COMPANY and the WIRELESS LAN PROVIDER are connected to the Internet for two-way communication with the other components shown connected to the Internet, as well as with other resources that are customarily connected to the Internet. Also, CLUB MEMBERS, who are drivers with a home PC or in a rented/borrowed vehicle with a laptop computer, are connected to the Internet, through which they may communicate with the SERVICE CENTER or with their own or another members vehicle. The CLUB MEMBERS, in addition to owning some of the vehicles shown, are a part of the general public who pay a use fee and connect through the SERVICE CENTER web page by using their member password. The SERVICE CENTER, which is the administrator of the embodiment system, is connected to the Internet. The Internet connections are according to any well-known technology, including optical, wireless, cable and satellite.

The system of FIG. 1 is duplicated at locations throughout the country with overlapping or adjacent service areas, much in the manner of cell phone service areas.

Each of the vehicles is provided with a COMPUTER, which has RAM (not shown but inherent), a CPU (not shown but inherent), a bus, STORAGE (a RAID or other non-volatile memory for mass storage), a WIRELESS LAN connection, a CELL PHONE MODEM, a SECURITY BUTTON, GPS, CAMERAS, a TEMPERATURE SENSOR, a SHOCK SENSOR, and a VELOCITY SENSOR. The WIRELESS LAN, GPS and CELL PHONE MODEM are commonly provided in vehicles, even as original equipment. A vehicle speedometer provides the function of the VELOCITY SENSOR. The air bag deployment system uses a shock sensor and functions as the SHOCK SENSOR. Standard engine controls require a temperature sensor to determine the intake air temperature, which is the environment temperature, and such component functions as the TEMPERTURE SENSOR. The SECURITY BUTTON is a simple button within easy reach of the driver and the front seat passenger, which is pressed to indicate an emergency situation, much in the manner of the well-known panic button of general usage.

The components of FIG. 1 are connected to the COMPUTER. The COMPUTER is a general-purpose computer that is operated by a general purpose operating system and the special purpose software of the embodiment implementing the method disclose herein, particularly with respect to the flowcharts of the drawing and their descriptions. Thus the COMPUTER is a special purpose computer.

The CAMERAS preferably comprise more than one video camera mounted on each member vehicle. The cameras are generally aimed in different directions, respectively, for example, forward, backward, to the right and to the left. On command from the SERVICE CENTER or within the VEHICLE through a joystick or the like (not shown), the CAMERAS are adjusted as to horizontal and vertical angles.

The member selectively activates the CAMERAS and controls how they operate. Various adjustments assure the quality of the images captured by the CAMERAS, which adjustments are standard with ordinary digital cameras. However, there are additional features specific to the purpose and the environment where this system is used, for example: Shutter speed control taking into account the vibration of the vehicle, the speed of the vehicle, ruggedness of the road and speed of the vehicle relate to the image to be captured; Exposure control taking into account environmental conditions, such as, extreme counter-light, facing to the sun and extreme darkness; Flash-lights that are enabled when certain conditions other than darkness are met, such as, risk from vandalism; Focus control to maximize object-depth; Resolution; and Light sensitivity.

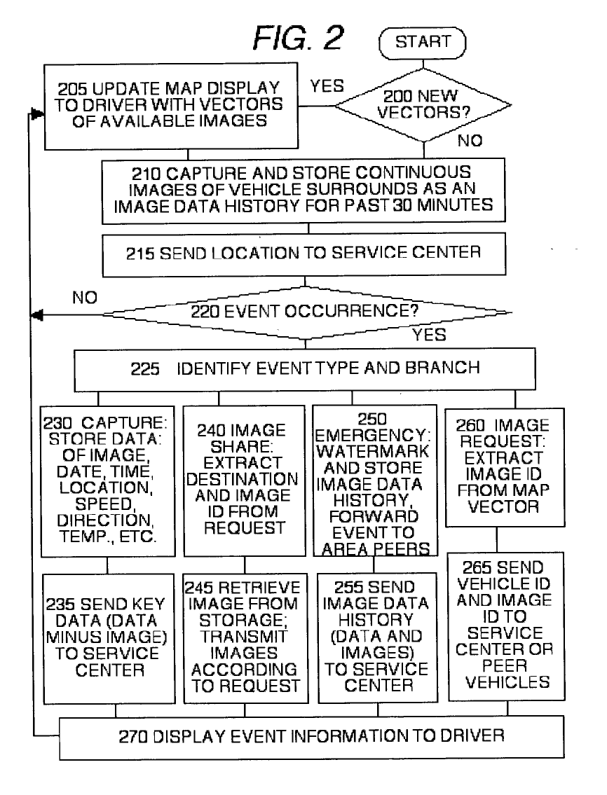

FIG. 2 discloses the method of operation of part of a vehicle system according to the embodiment.

Step 200, FIG. 2: Images are captured by the CAMERAS of FIG. 1, while a VEHICLE is running on a road or while the VEHICLE is parked, and the VEHICLE sends key data to the SERVICE CENTER, with or without an image associated with the key data, as shown in FIG. 1. The SERVICE CENTER reviews the key data and determines when a corresponding image is already in storage (in the service center or another vehicle); and if the currently received key data indicates a new or significantly more current image is involved, then processing passes to step 205, otherwise, processing passes to step 210.

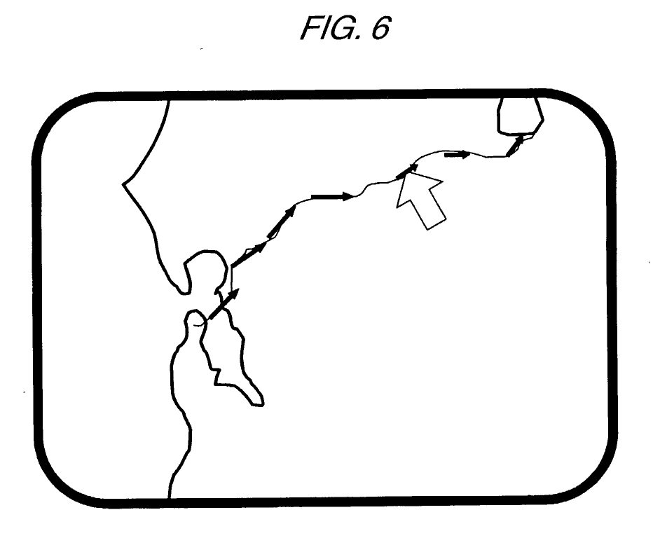

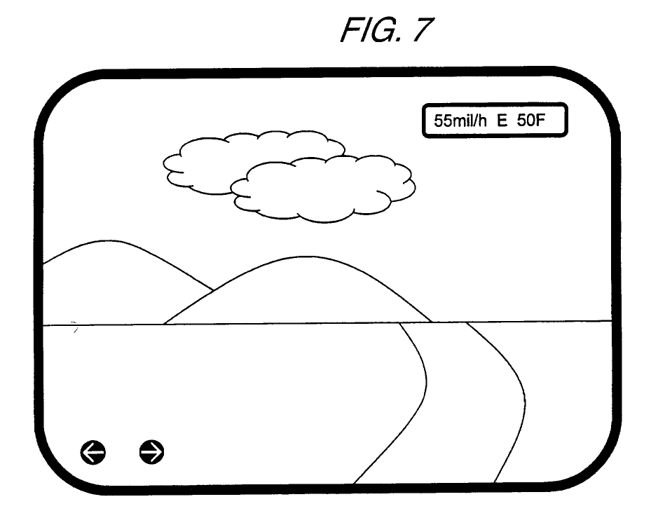

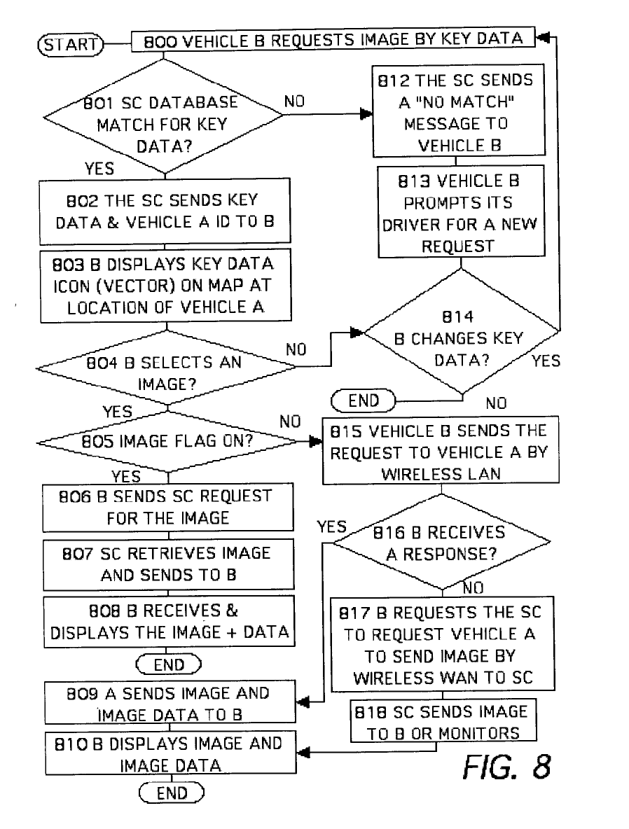

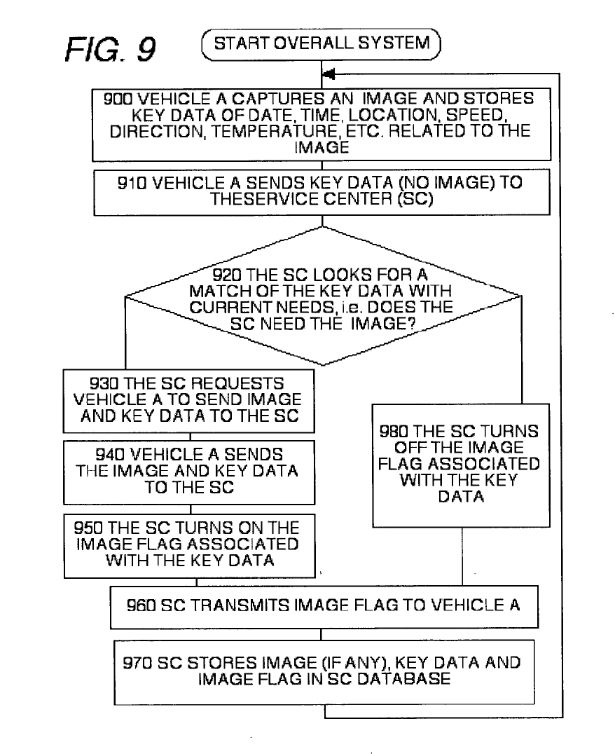

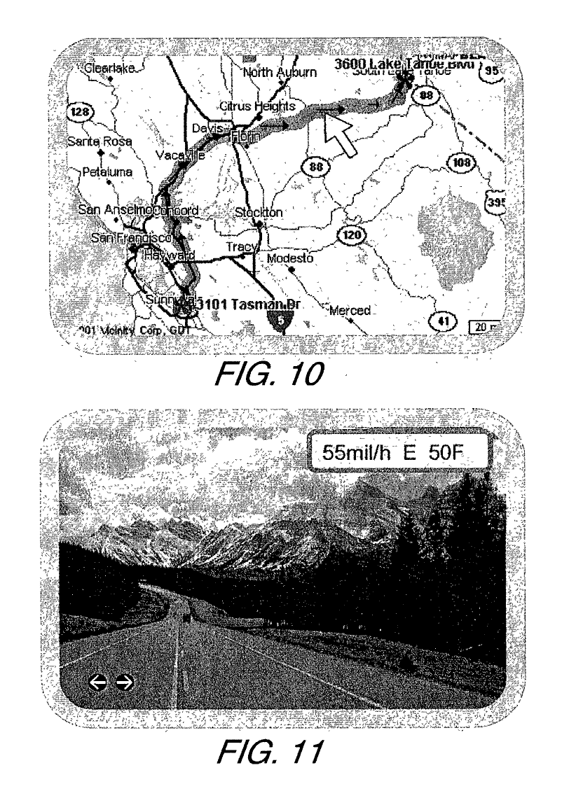

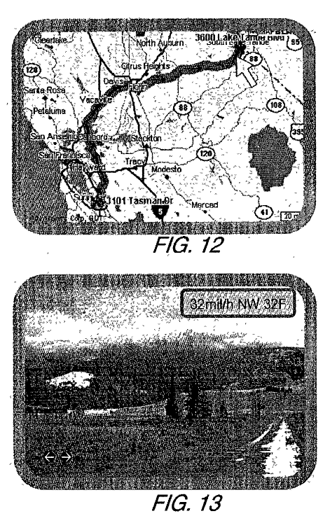

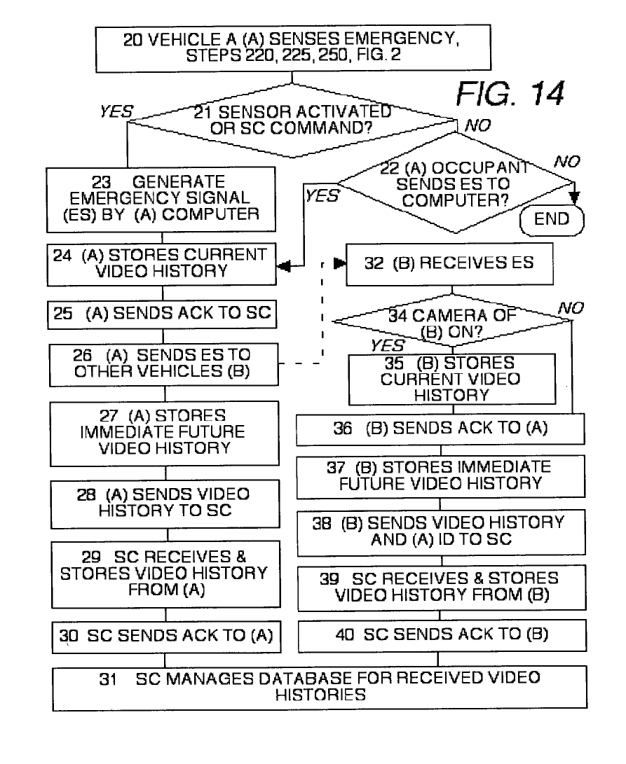

Step 205, FIG. 2: The service center sends the key data or an image icon representing the key data to the vehicles and updates the map shown in FIGS. 6, 10 and 12, which map includes image icons (vectors, i.e. arrows along the route in the map figures, indicating the location where the key data was captured. As a broad equivalent to sending the key data or a vector to the vehicles for the vehicles to update their map, the updated map may be sent by the service center to the vehicles.

In FIGS. 6, 10 and 12, the image icons are displayed on the maps to show position, speed, direction of capture and other data such as temperature. The image icons indicate that the images are available and where the images were captured. The image icons blink on and off to emphasize their presence. The arrow expresses the speed and direction, like a vector in geometry. For example, when the vehicle that will provide the image or that already provided a stored image (imaging vehicle) is driving 30 mph (miles per hour) to the south, the vector is displayed as an arrow pointing to the south with a length proportioned relative to other arrows to indicate the 30 mph. The user makes the choice easily, since the arrow intuitively shows the position, direction and speed of the imaging vehicle at the same time in a single display icon.

Step 210, FIG. 2: The vehicles with active cameras capture and store continuous images (the images will in fact be taken at a finite frequency, for example above the flicker rate of the human eye for movies or at a slower rate like a slide show, but preferably periodically). These images are stored within the vehicle for a period of current time, for example for 30 minutes. As a new image frame is captured, an oldest frame (one captured 30 minutes ago, for example) is discarded. The System is designed to meet broad application demands, and hence captures various data associated with images. Other data are keyed with each image or with a group of images with respect to a particular itinerary, or the other data is stored independent of any image.

In step 210, the data representing the images is sent from the cameras to the vehicle computer (COMPUTER in FIG. 1). The vehicle computer generates a data package of the images and relevant other data. The data package or packet includes: Images; GPS coordinates or other information on location of the vehicle (for example, street and city names retrieved from the navigational system); When the image was captured; Name of objects in an image, which could be extracted with an object recognition system, for example nearby buildings, points of interest and landmarks; Date that the image was captured; Time that the image was captured; Velocity of the vehicle when the image was captured; Direction of the vehicle when the image was captured; Three-dimensional direction of the camera when the image was captured; Temperature of the environment around the vehicle; Humidity of the environment around the vehicle; Pressure of the environment around the vehicle; Road conditions, for example, wet, icy, snow-pile and bumpy; Weather conditions, for example rain, fine, sunny or cloudy; Other sensor data; and Profile of the driver, the passengers or the vehicle.

In step 210 of FIG. 2, the CAMERAS of FIG. 1 capture still and moving images for use upon the occurrence of certain events (for example, the events referred to in FIG. 2, steps 220 and 225). A more complete listing of event examples than the examples of steps 230, 240 and 250, is as follows: When a specified time-period has passed since the taking of the last image, such as after 30 seconds (step 230); When the vehicle has traveled a specified distance since the taking of the last image, such as after a quarter of a mile (step 230); When the vehicle makes a turn more than a set number of degrees in a set time period, for example at a corner, merging onto a highway, or at a junction (step 230); When a certain normal environmental object is detected through object recognition, such as a sign or building that is related to the destination or purpose of the drive (step 230); When a certain object or signal is detected that is installed for the purpose of activating the capture of an image and data, such as an object or transmitter/re-transmitter set at a particular location beside the road (step 260); When a signal is transmitted from the service center commanding the taking of a picture (step 240); When the driver, passenger or other occupant of the vehicle commands the taking of an image (step 260); When a signal is transmitted from another vehicle commanding the taking of a picture (step 240); When the sensor system detects danger to the vehicle or occupants through behavior of the vehicle, for example acute extreme braking, acceleration, deceleration, quick steering change, or abnormal shock to the vehicle body, such as upon a collision or due to vandalism (step 250); When certain dangerous situations are detected externally of the vehicle, such as a relatively slow object straight ahead on the road or a fast object coming up in the path of the vehicle from any angle (step 250); and When unknown or undesirable access or attempted access to the vehicle is detected, for example, an attempt to open locked doors without using the key, an attempt to start the vehicle without using the key, or intrusion of an area around the vechicle (step 250).

As an enhancement of step 210 of FIG. 2, in addition to providing sensors to determine the occurrence of the above events, there are plural sensors 1-N (SENSORS in FIG. 1) to sense data useful to others than the occupants, owner and passengers of the vehicle. These environmental sensors detect the speed of the vehicle, direction of the vehicle, location of the vehicle and temperature of the environment. The resulting environmental data is sent to the vehicle computer. The sensors are built into the vehicle. The cost of the sensors is reasonable, and technologies for the sensors are available on the market.

Step 215, FIG. 2: The vehicle GPS automatically determines the vehicle location and periodically sends the vehicle location to the service center, with or without images.

Step 220, FIG. 2: The vehicle computer tests for the occurrence of one of the events of steps 230, 240, 250 and 260. When an event is not detected, processing returns to step 205 for the vehicle computer (step 200 is performed by the service center computer). When an event is detected, processing passes to step 225.

Step 225, FIG. 2: The event is compared to certain events and processing is then passed to a correspondingly event selected further step, for example to one of the steps 230, 240, 250 and 260.

Step 230, FIG. 2: This step is reached upon the occurrence of the event of the capture of an image, which may be of general interest to others, and which event is automatically triggered to occur after a fixed number of minutes since the last such event or rounding a corner or upon traveling a certain distance, for example; the possibilities are discussed elsewhere. The data is then stored in the vehicle storage. The stored data includes image, date, time, location, speed, direction, temperature, etc., as discussed elsewhere.

Step 235, FIG. 2: Key data (for example, the data minus the image) is transmitted wirelessly to the service center by the vehicle. The image may not be transmitted at this time to the service center. The key data includes data evaluated by the service center in step 200.

Step 270, FIG. 2: The driver selects a mode of operation wherein the occurrence of the event is noted on the display, or the image of the event is displayed, or the display is not changed by the event of steps 230 and 235. After step 270, processing returns to step 205 for the vehicle.

Step 240, FIG. 2: This step is reached upon the occurrence of the event of the vehicle receiving a command or request to share one or more of its stored or future images with another vehicle directly or indirectly through the service center (peer to peer), or to share one of its stored or future images with the service center, etc., as explained elsewhere. The image share request or command is parsed, and then the destination for the image and an image ID, which may be key data or merely a location and direction for a current image, are extracted. For a request of a future image, the vehicle computer modifies the image capture frequency or shutter speed, etc. according to the vehicle velocity and modifies other camera parameters, such as focus and depth of field. Shutter and other camera control signals are sent to the cameras from the vehicle computer.

Step 245, FIG. 2: The image ID is used to retrieve the image from the vehicle storage, its database. Then, the image or images are transmitted to the destination, according to the request or command.

Step 270, FIG. 2: The driver may select a mode of operation wherein the occurrence of the event is noted on the display, or the image of the event is displayed, or the display is not changed by the event of steps 240 and 245. After step 270, processing returns to step 205 for the vehicle.

Step 250, FIG. 2: This step is reached upon the occurrence of an emergency event of the type discussed elsewhere, for example the vehicle detecting an accident or near accident involving the vehicle or a nearby vehicle, or receipt of an emergency signal for the vehicle or all vehicles at the location area of the vehicle, which emergency examples are set forth in more detail elsewhere. The image data history from step 210 is immediately permanently stored and preferably a future image history for the next fixed or requested period of time is appended and stored. For a request of a future image, the vehicle computer modifies the image capture frequency or shutter speed, etc. according to the vehicle velocity and modifies other camera parameters, such as focus and depth of field. Shutter and other camera control signals are sent to the cameras from the vehicle computer.

Step 250, FIG. 2: While the image data is being captured for the image data history or upon detection of the occurrence of the emergency event or upon permanent storage after occurrence of the event is detected, each image frame is watermarked to secure the image and provide legal proof that the image was not tampered with after capture, so that the image becomes tamperproof for later assuring reliability as evidence in court or the like. When the emergency event signal was generated within the vehicle, for example when the vehicle is involved in an accident, the vehicle transmits an emergency event signal wirelessly to other vehicles near the vehicle. Also the event signal received from another vehicle or the service center may be retransmitted to nearby vehicles to assure their reception of the event signal. Furthermore, an independent authority, such as the state highway patrol or local police, may generate the emergency request and send it to the vehicles directly or through the service center when the authority notes an accident or a crime in the area. The driver of the vehicle may also generate the emergency event, for example by activating an emergency button.

Step 255, FIG. 2: The image data history (key data, watermarked images and identification of the emergency mode) is transmitted to the service center, another vehicle that generated the original emergency event signal, and the authority that generated the original emergency event signal.

Step 270, FIG. 2: The driver may select a mode of operation wherein the occurrence of the emergency event is noted on the display, or the image of the event is displayed, or the display is not changed by the event of steps 250 and 255. The occurrence of the emergency event may trigger an immediate warning, visually with a flashing display and/or audibly with an alarm and an emergency message on the display, as an alert to the driver that an emergency has probably occurred in the area and the driving should be adjusted accordingly. After step 270, processing returns to step 205 for the vehicle.

Step 260, FIG. 2: The driver or other occupant of the vehicle may generate an image request event, for example by clicking or double clicking on an image ID, image vector or other image icon, on the map displayed in the vehicle, for example the map of FIG. 6, or enter a location, for example GPS coordinates, or activate a button for the vehicle's current location, that is the driver or other occupant of the vehicle, can request capturing the images by voice, curser or button actuation command, for example.

Step 260, FIG. 2: The information from the sensors and the commands, from inside or outside the vehicle, are sent to the vehicle computer, where the information and commands are processed for the determination of the image capture frequency. The vehicle computer modifies the image capture frequency or shutter speed, etc. according to the vehicle velocity and modifies other camera parameters, such as focus and depth of field. Shutter and other camera control signals are sent to the cameras from the vehicle computer.

Step 260; FIG. 2: When a user wants to check the situation of a particular location with live images, first the user visits the web-site of the service center and then enters the location information, such as address, street name, highway number, city or town, GPS coordinates, landmark, point of interest and Zip code. The vehicle system also accepts input by pointing devices such as a mouse, a track ball and a light pen for PCs laptops or in-dash displays, whereby the user points to the desired location or image icon on a displayed map, for example the display map of FIGS. 6, 10 and 12. The images available, in storage at the service center or on another vehicle, are displayed as blinked lights and arrows (image icons) on the display or screen. A traveler, in researching the most appropriate way to get to a destination, may use the navigation system to display the images available on a proposed route.

Step 265, FIG. 2: The vehicle transmits its vehicle ID and the requested image ID (key data) to the service center or to other vehicles directly or indirectly (peer-to-peer). This peer-to-peer transmittal would be an event of step 240 for the other vehicles. Then, according to the normal course of events, the vehicle receives the image.

Direct information exchange between vehicles by wireless LAN (peer-to-peer transmission) is efficient in quickly changing situations, for example, a traffic jam. If a driver wants to know the cause of a traffic jam and how long the traffic jam may last, the driver requests images from the other vehicles on the road ahead and then the driver receives the available images from other vehicles directly or through the service center.

Step 270, FIG. 2: The image of the event is displayed. After step 270, processing returns to step 205 for the vehicle.

Except for step 200, which is performed at the service center, a vehicle performs the method of FIG. 2.

The service center manages its database, which includes a directory of the images stored at the service center, the images stored at the service center, a directory of images stored at mobile, data associated with the images or locations, and location information associated with either the images or the data. Statistical analysis of the images and data are performed and stored.

In response to an information request, for example from steps 260 and 265 of FIG. 2, the service center retrieves the most appropriate images or mobile image location and data by accessing its database. With respect to images stored at a location other than at the service center, the service center requests the release of such images and provides destination information, to a vehicle for transmission to another vehicle, that is, peer-to-peer transmission of steps 240 and 245 of FIG. 2. If the owner of the requested vehicle doesn't permit the release, an option available to the service center is the release of other less pertinent images available to the public. The information thus released to the public doesn't have any private or personal information, so the public cannot detect the personal origin of the images.

The service center provides data and results of analyses to the customers or members, including: Current traffic situation of a specified road or other location, with picture images; Unresolved accidents and construction sites on a specified road or other location, with images; Weather around the specified location, with images; Statistics of congestion of a specified road or other location, by day or by time; Secured images on a critical event, for example, an image at an accident, upon the occurrence of vandalism to the vehicle, upon the occurrence of theft of the vehicle; Access to statistics of all data published on the service center web site; and Arbitration between a viewer and the owner of data, for peer-to-peer image transfer.

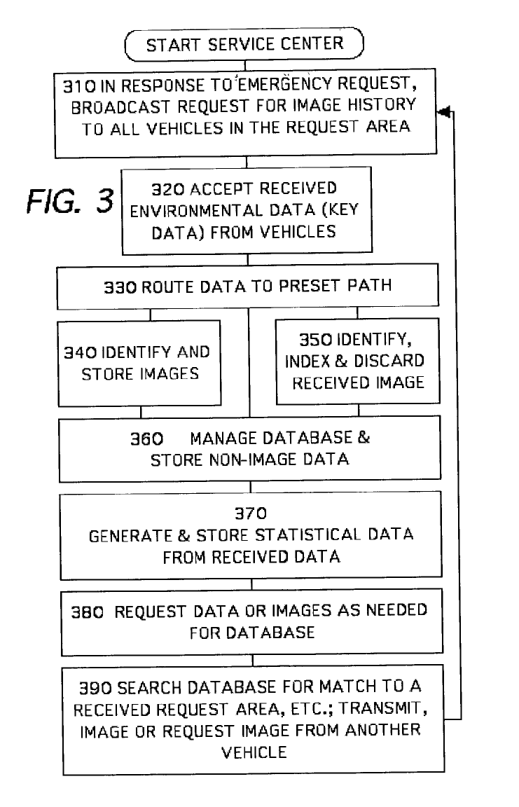

FIG. 3 sets forth a part of the embodiment method from the point of view of the service center.

Step 310, FIG. 3: As mentioned, an emergency request or command may originate at a vehicle or an authority, for example. Upon receipt of an emergency request or command, the service center will broadcast a request for an image history from all or selected ones of vehicles in the area associated with the request or command. Upon receipt of the request or command, each vehicle processes it according to steps 220, 225, 250, 255 and 270 of FIG. 2.

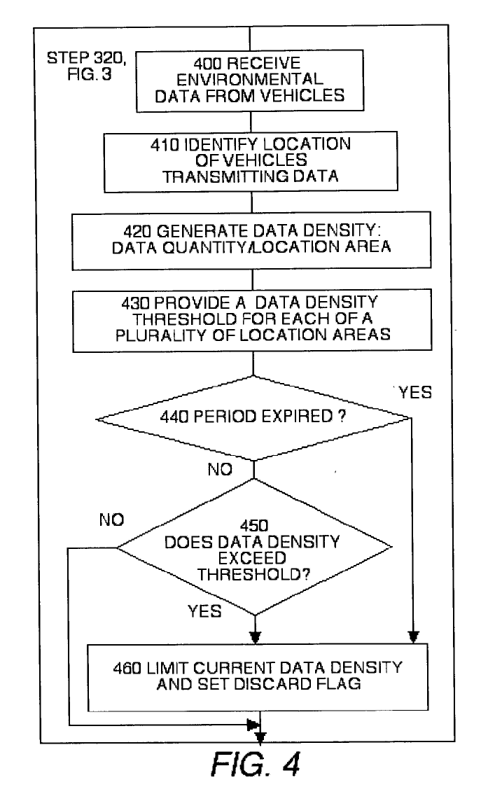

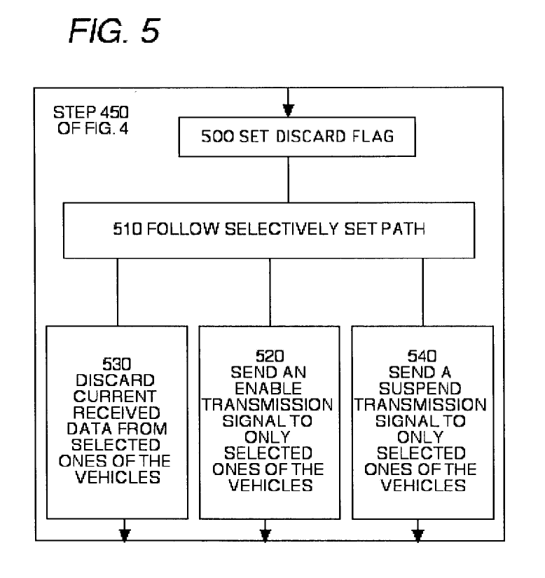

Step 320, FIG. 3: The service center receives any environmental data (for example, key data with or without images) from the vehicles that transmitted such data according to steps 220, 225, 230, 235, 240, 245, 250 and 255 of FIG. 2. The service center activities with respect to steps 260 and 265 are clear from the discussion of steps 200 and 205 of FIG. 2. Further details of step 320 are set forth with respect to FIG. 4.

Step 330, FIG. 3: When the received data includes one or more images that are of use to the service center, the processing proceeds to step 340, otherwise, processing proceeds directly to step 360. A received image may be of interest when the service center has little data from that location, and for other reasons apparent from the discussion with respect to FIG. 4.

Step 340, FIG. 3: The received images are identified using the key data, which identity is used in a directory, and the images are stored.

Step 350, FIG. 3: The received images are discarded when they are not interest to the service center or when the vehicle of origin stores the images, and for other reasons apparent from the discussion with respect to FIG. 4.

Step 360, FIG. 3: The database of the service center is managed in a known manner so that the images and key data are retrieved as needed.

Step 370, FIG. 3: The key data and information extracted from images is retrieved and processed to generate statistical data and other data, for example about weather conditions and forecasting, in a known manner.

Step 380, FIG. 3: In response to a request from a vehicle for an image that is not in storage at the service center or another vehicle as indexed at the service center, or for an image that is not current even though in storage, or for an image needed for step 370, the service center requests an image (for example, by location, direction and angles) from one or more vehicles. Such a request is received by the respective vehicles and treated as an event of steps 240 and 245 of FIG. 2.

Step 390, FIG. 3: When the service center receives a request (for example a request that was generated and transmitted according to steps 260 and 265 of FIG. 2), the service center searches its database in a known manner, for example using the directory, in an attempt to locate a match to the received request's key data, for example as to a particular location or area. When such a match is found, the image is transmitted to the requester. When such a match is not found, a request is made to one or more vehicles for the capture or retrieval of such an image, which would be an event of steps 240 and 245 of FIG. 2 from the point of view of the vehicle. Then processing returns to step 310.

The suspension function within the embodiment method of managing data is shown in FIG. 4, as further processing details for step 320 of FIG. 3.

Step 400, FIG. 4: Environmental data, including key data, images and other data, is received from the vehicles by the service center. The data was sent according to any one of steps 235, 245 and 255 of FIG. 2. Data transmitted by wireless transmission from the plurality of vehicles is received at the service center. The content of the data has been discussed above and generally relates to information about the environment of the vehicle, within the vehicle, concerning the vehicle and its passengers, and without the vehicle. The data is current from the viewpoint of the service center, in that it has just been received by the service center. Most preferably, but not necessarily, the data is also current from the viewpoint of the vehicles in that it has just been captured by environment data collecting sensors of the vehicles, including the cameras.

Step 410, FIG. 4: The service center determines the location of origin of the environmental data as identified from the key data. The location of the vehicles is identified, for example from a packet header in a known manner or providing a field that has exact location GPS coordinates or a code indicating an area that was determined by the vehicle computer from GPS coordinates or from object recognition or the like as previously explained. This step is useful for other purposes, for example in indexing the database.

Step 420, FIG. 4: Using information in its database, for example the directory, the service center determines the quantity of images or other data that is current and in storage for the location area, and calculates a representation of the data density, including image density, for that area. With respect to one type of data density, for example a northerly viewed image, the service center computer generates data density representations related to current data quantity per different location areas. The number of such images being received from other vehicles for the same area, including recently received images, is determined as the density. Images of a certain age, outside of a time period as measured from their capture, may be discarded as long as other images more recent are in storage. Images in storage refers to data being in storage at the service center that could be used to recreate or display the image, or data in storage on the memory of the vehicle that captured the image, which data could be used to recreate or display the image. Step 420 could be moved, for example to be executed after step 440.

Step 430, FIG. 4: The service center calculates or retrieves from storage a threshold image or other data density value for the area. In generating the software to create a special purpose computer from a general purpose computer that is used at the service center, a data density threshold value is provided for, which value is set by the programmer and/or selectively set by an operator of the computer at the service center as the needs of the system change, thereby limiting current data density to at or below a set amount. In such a manner, a separate threshold value is set for each of a plurality of image and other data types for each area, which areas may be changed. For example, an area may be along a specific highway, a quadrant of a city, a town, a county of a state or even a state, and the areas would probably be different for different types of data, for example, county wide for a temperature and along a highway for images and an intersection within a city. Step may be changing the setting or keeping a value in storage until needed in step 450.

Step 440, FIG. 4: The period of time within which data is valid or current for the area is compared to the time of capture, which is within the key data. When the image data is determined to be old a discard flag is set in step 460 and processing passes through step 330 to step 350 of FIG. 3. When the image data is determined not to be old the procedure passes to step 450. Although not necessary, it is desirable that the need for a suspension in receiving data should not be reviewed upon the receipt of each separate data, to thereby require less computing power and delay. Therefore, a time period is set and selectively changed. For example, the time period may be five minutes for images and 30 minutes for temperature, with some automatic adaptive setting, for example if the temperature is in close proximity to freezing, the period is reduced. If the time period has not expired for the type of data being received, then processing passes from step 320 to step 330 of FIG. 3. To further save computing time, steps 420 and 430 may be moved to occur after step 440 and before step 450.

Step 450, FIG. 4: The data density derived in step 420 is compared with the threshold provided by step 430. When the generated data density exceeds the data density threshold, processing proceeds to step 460 and otherwise proceeds through step 330 to step 340 of FIG. 3. The current data density is limited by a fixed one of the following methods or a selected one of the following methods, according to step 500 of FIG. 5. The methods of limiting may vary, for example as respectively explained in steps 510, 520 and 530, in FIG. 5.

Step 460, FIG. 4: Step 460 is reached from either step 440 or step 450, as explained above. Step 460 is shown in more detail in FIG. 5.

Step 500, FIG. 5: The discard flag is set according to the conditions mentioned above in the description of steps 440 and 450 of FIG. 4.

Step 510, FIG. 5: Three paths from step 510 provide three different selectable example methods of limiting current data density. For example, the path selected in step 510 may be chosen by including only one of steps 520, 530 and 540, or by disabling some of steps 520, 530 and 540 at set-up or during programming, or by a hardware or software switch under control of an operator at the service center, or automatically according to the type of vehicle systems to which the signal is to be sent.

Step 520, FIG. 5: An enable transmission signal to enable step 235 of FIG. 2 is sent to only some of the vehicles within the area of high density. The enable transmission signal may include a location area wherein the enable transmission signal is valid or a time wherein the enable transmission signal is valid.

Step 530, FIG. 5: The service center discards the image data from the area of high density and does or does not send a signal to the vehicles. Thereafter, processing proceeds from step 320 to step 330 of FIG. 3. Steps 400 to 460 may be repeated for various types of data that are received within the same packet from the same vehicle.

Step 540, FIG. 5: A suspend transmission signal to suspend step 235 of FIG. 2 is sent to a selected some or all of the vehicles within the area of high density. The suspend transmission signal may include a location area wherein the suspend transmission signal is valid or a time within which the suspend transmission signal is valid.

Thereby, according to FIGS. 3, 4 and 5, the data is selectively circulated according to step 235 of FIG. 3, from a vehicle that captured the data, according to its need. The data is shared with others, when there is no suspension signal generated by the service center for the location area involved (enable signal of step 520 or discard signal of step 530 or suspend signal of step 540) from the service center. The suspension signals are generated by the service center and used at the service center (step 530) or sent to selected vehicles (steps 520 and 540) on the same or close roads (an example of an area) so that only adequate numbers of vehicles on a busy road are to transmit the data to the service center or transmit images peer-to-peer. The service center generates suspension signals when it receives too much data from the same area. The vehicle computer may release the suspension when the vehicle leaves the busy road or area, for example, as determined automatically with a permissible location range within the signal from the service center and the vehicle GPS location sensor. Alternatively, the service center releases the suspension by sending the suspended vehicles a resumption signal, which may merely be the curtailment of the suspend signal of step 540. Similarly, the resumption signal may be the general broadcast to all vehicles of the enable signal of step 520. The vehicle will resume transmitting the data according to step 235 when the suspension is released. The system is set up so that users may selectively enable and disable data transmission from their own vehicle, particularly for privacy reasons.

FIG. 14 is a flowchart of the portion of the embodiment method relating to a vehicle sensing an emergency or an occupant of the vehicle declaring and emergency to capture a video history of the event.

Step 20, FIG. 14: The vehicle (A) senses and emergency event, for example as disclosed with respect to steps 220, 225 and 250 of FIG. 2. The emergency event may be sensed by an occupant of vehicle (A) or sensed by one of the sensors of vehicle (A), for example, the sensing of strong braking (the sensor being the deployment of the ABS), an air bag deployment, and an intruder trying to get inside the vehicle (A), which indicate that the vehicle (A) has had an accident, has just avoided and accident or in some way has trouble.

Step 21, FIG. 14: Did the sensing of an emergency originate with a vehicle sensor as distinguished from an occupant of the vehicle (A), for example? When the inquiry and decision of the vehicle (A) computer system reaches a yes result, processing passes to step 23 and otherwise passes to step 22.

Step 22, FIG. 14: The computer system of vehicle (A) inquires as to whether an occupant will confirm the sensed occupant ES command or accept and ES command that originated outside of the vehicle (A), for example, from the service center (SC) of another vehicle (B). When yes is a result of the inquiry, as entered by an occupant of the vehicle (A), processing passes to step 24, and otherwise, processing ends. As a further enhancement, if the vehicle is unattended, for example as indicated to the vehicle computer system in stand-by mode as when parked or the engine off, processing proceeds automatically to step 24 after setting a confirmation flag, processing continues to step 28 and stops until an occupant of the vehicle is informed and chooses to clear the confirmation flag so that processing may proceed to execute step 28.

Step 23, FIG. 14: The computer system of vehicle (A) generates an emergency signal (ES).

Step 24, FIG. 14: Vehicle (A) then permanently stores its current video history, for example by preventing the overwriting of the current video history with the next video images that are captured (setting an overwriting-inhibition-flag).

Step 25, FIG. 14: Vehicle (A) sends an acknowledgement (ACK) to the service center (SC) over a wireless WAN (such as a cell phone system) to inform the service center of the emergency. The ACK includes key data, such as the identity of vehicle (A), the location of vehicle (A), the current date, the current time and the nature of the emergency. The service center may inform road authorities or services about the emergency, for example inform the police and request emergency services, this service may depend upon the severity of the emergency. Also, the service center may command other vehicles within the immediate are of the emergency to witness the event, which would involve a service center command (SC) such as that referred to in step 21.

Step 26, FIG. 14: The vehicle (A) sends the emergency signal (ES) to other vehicles (B) over a wireless LAN and limits the effectiveness of the emergency signal, for example the signal is sent with a low power so that it may only be received by other vehicles (B) that are in the immediate area of the emergency event. The ES includes key data, such the identity of vehicle (A), the location of vehicle (A), date, time and the nature of the emergency, as well as a Capture-image-command.

Step 27, FIG. 14: Vehicle (A) then proceeds to permanently store the immediate future video history as a continuation of the current video history of step 24. The future video history is controlled by a timer that starts with step 24 and continues for a period of time that is fixed or automatically selected by the computer system according to the severity of the emergency.

Step 28, FIG. 14: Vehicle (A) transmits the video history (including the current video history and its continuation, which is the immediate future video history) to the service center over a wireless WAN (such as a cell phone system). The video history includes key data for its identification, images and other environmental data such as temperature, an audio record from within and without the vehicle and weather factors.

Step 29, FIG. 14: The service center (SC) receives and permanently stores the video history sent to it in step 28. The storage is indexed and entered in the emergency services directory according to the key data.

Step 30, FIG. 14: The service center sends an acknowledgement (ACK) back to the vehicle (A) after determining that the video history was received and stored in good order, and also acknowledges the deployment of any road authority or road service, which acknowledgements are displayed at the vehicle (A). Until receiving the acknowledgement, vehicle (A) repeatedly transmits to the service center.

Step 31, FIG. 14: The service center manages its database for received video histories, by establishing and maintaining indexes, directories, etc. as is common for such management, and the service center distributes the information according to the lawful needs of others, without violating the privacy of individuals.

Step 32, FIG. 14: The vehicle (B) receives the emergency signal ES transmitted in step 26, because vehicle (B) is within the range of the wireless LAN with vehicle (A).

Step 34, FIG. 14: The vehicle (B) computer system determines whether its cameras are on and functioning. When the cameras are on, processing passes to step 35, and when the cameras are off, processing passes to step 36.

Step 35, FIG. 14: The vehicle (B) computer system stores its current video history, for example by preventing the overwriting of the current video history with the next video images that are captured (setting an overwriting-inhibition-flag).

Step 36, FIG. 14: The vehicle (B) computer system sends an acknowledgement (ACK) to the vehicle (A) over the wireless LAN to inform vehicle (A) that it is capturing image data. The ACK includes key data, such the identity of vehicle (B), the location of vehicle (B), date and time.

Step 37, FIG. 14: The vehicle (B) computer system then proceeds to permanently store the immediate future video history as a continuation of the current video history of step 35. The future video history is controlled by a timer that starts with step 35 and continues for a period of time that is fixed or automatically selected by the computer system according to the severity of the emergency.

Step 38, FIG. 14: The vehicle (B) computer system transmits the video history (including the current video history and its continuation, which is the immediate future video history) to the service center over a wireless WAN (such as a cell phone system). The video history includes key data for identification of vehicle (A) as the requestor and vehicle (B) as the source of the data, images and other environmental data such as temperature, an audio record from within and without the vehicle, and weather factors.

Step 39, FIG. 14: The service center (SC) receives and permanently stores the video history sent to it in step 38. The storage is indexed and entered in the emergency services directory according to the key data.

Step 40, FIG. 14: The service center (SC) sends an acknowledgement (ACK) back to the vehicle (B) after determining that the video history was received and stored in good order, which acknowledgement is displayed at the vehicle (B). Until receiving the acknowledgement, vehicle (B) repeatedly transmits to the service center.

Step 31, FIG. 14: The service center manages its database for received video histories, by establishing and maintaining indexes, directories, etc. as is common for such management, and the service center distributes the information according to the lawful needs of others, without violating the privacy of individuals.

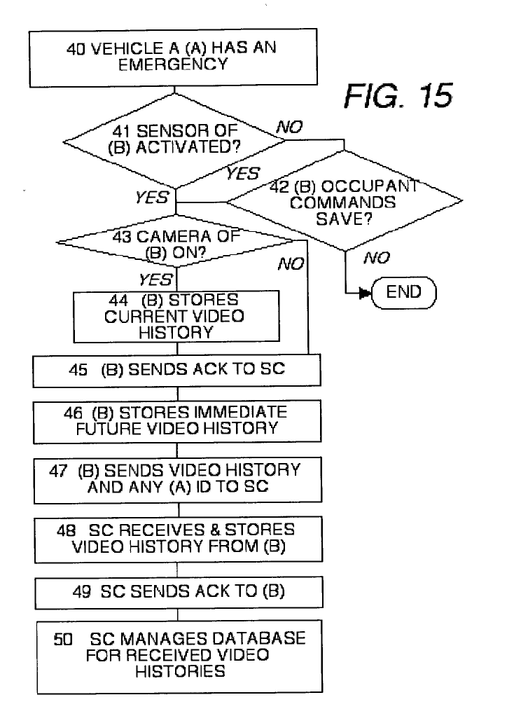

FIG. 15 is a flowchart of the portion of the embodiment method relating to a vehicle (B) sensing an emergency originating with another vehicle (A) or an occupant of the vehicle (B) declaring an emergency based upon what they have observed with respect to vehicle (1) having an emergency, to capture a video history of the event.

Step 40, FIG. 15: The vehicle A) has an emergency event of the type discussed with respect to FIG. 2, steps 220, 225, 260 and 265.

Step 41, FIG. 15: The vehicle (B) determines if the sensing of an emergency originate with a vehicle sensor as distinguished from an occupant of the vehicle (B), for example? When the inquiry and decision of the vehicle (B) computer system reaches a yes result, processing passes to step 43 and otherwise passes to step 42.

Step 42, FIG. 15: The vehicle (B) computer system inquires as to whether an occupant will confirm the sensed occupant ES command. If yes is a result of the inquiry, as entered by an occupant of the vehicle (B), processing passes to step 43, and otherwise, processing ends. As a further enhancement, if the vehicle is unattended, for example as indicated to the vehicle computer system in stand-by mode as when parked or the engine off, processing proceeds automatically to step 43 after setting a confirmation flag, processing continues to step 47 and stops until an occupant of the vehicle is informed and chooses to clear the confirmation flag so that processing may proceed to execute step 47.

Step 43, FIG. 15: The vehicle (B) computer system determines whether its cameras are on and functioning. When the cameras are on, processing passes to step 44, and when the cameras are off, processing passes to step 45.

Step 44, FIG. 15: The vehicle (B) computer system stores its current video history, for example by preventing the overwriting of the current video history with the next video images that are captured (setting an overwriting-inhibition-flag).

Step 45, FIG. 15: The vehicle (B) sends an acknowledgement (ACK) to the service center (SC) over a wireless WAN (such as a cell phone system) to inform the service center of the emergency that involves vehicle (A). The ACK includes key data, such the identity of vehicle (A) if known or perceived by the vehicle optical recognition system, the location of vehicle (B), date, time and the nature of the emergency. If vehicle (A) or some other vehicle has not yet informed the service center, the service center may inform road authorities or road services about the emergency, for example inform the police and request an ambulance, this service may depend upon the severity of the emergency. Also, the service center may command other vehicles within the immediate are of the emergency to witness the event, which would involve a service center command (SC) such as that referred to in step 21 of FIG. 14.

Step 46, FIG. 15: The vehicle (B) then proceeds to permanently store the immediate future video history as a continuation of the current video history of step 44. The future video history is controlled by a timer that starts with step 35 and continues for a period of time that is fixed or automatically selected by the computer system according to the severity of the emergency.

Step 47, FIG. 15: The vehicle (B) computer system transmits the video history (including the current video history and its continuation, which is the immediate future video history) to the service center over a wireless WAN (such as a cell phone system). The video history includes key data for indentification of vehicle (A) as the vehicle having the emergency and vehicle (B) as the source of the data, images and other environmental data such as temperature, an audio record from within and without the vehicle, and weather factors.

Step 48, FIG. 15: The service center (SC) receives and permanently stores the video history sent to it in step 47. The storage is indexed and entered in the emergency services directory according to the key data.

Step 49, FIG. 15: The service center (SC) sends an acknowledgement (ACK) back to the vehicle (B) after determining that the video history was received and stored in good order, which acknowledgement is displayed at the vehicle (B). Until receiving the acknowledgement, vehicle (B) repeatedly transmits to the service center.

Step 50, FIG. 15: The service center (SC) manages its database for received video histories, by establishing and maintaining indexes, directories, etc. as is common for such management, and the service center distributes the information according to the lawful needs of others, without violating the privacy of individuals.

The customers for the service provided by the embodiment may be classified as non-members or members.

Non-members can access public pages of the service center web-site to look at the availability of data, including images, on a map display. Some information may be free to view or download in order to create interest among the general public, while other information may be available for a one-time fee.

Members have full access to the company's web-based services, such as traffic information services, arbitrary information retrieval to the data center, etc. Members pay a periodic fee, have equipment installed on their vehicle, and get more services enabled by the equipment, such as wireless communication to the service center and information sharing directly between local vehicles. Members can scan the potentially interesting images over the Internet or by direct wireless communication with the service center, which may store the images or extract availability from a directory and command another vehicle's computer to transmit an image directly to the requesting vehicle or through the service center. According to the degree of contribution in presenting data through or to the service center, members are awarded points used to discount the member's periodic fee. The member's personal information and data is securely kept by the service center and cannot be retrieved unless permitted by the owner.

The data packet, including images and the associated information is used to know the current traffic and road situation before an approach to a particular area, so that a driver can evaluate the route. The data packet also provides navigational information such as remarkable signs, buildings and views along the driving route. For example, data captured at a location of interest by other vehicles within the last 10 minutes is sorted by mileage along a route of each highway of interest. The thus organized data is made available to drivers and used to assess current road traffic at the locations of interest before arriving at the locations. Also the service center or the vehicle computer extracts statistical information concerning the area and the traffic for each road of interest.

The data is useful: To communicate with family and others who are not driving together, but rather driving in different vehicles over the same route at the same or different times; To remotely check a parked vehicle; For publishing on a web-site, so that it is accessed by anybody who has Internet and web access; As a record for each driver to plan or recall a drive based upon their experience, for example, reminding the user of the name of the road and good views; As crucial proof of an accident for the owner or for other vehicles coincidentally encountered by the data capturer; To select the most appropriate way to a destination. To know the current weather at a desired location, with live images from other vehicles; To obtain images captured at the scene of an accident or the scene of a crime by one or more vehicles, which images may then be used as evidence of responsibility for the accident or crime; To obtain the images in a more cost efficient manner by sharing among a plurality of vehicles, rather than by building an infrastructure of road fixed cameras and sensors; and For sale, particularly with respect to traffic and weather conditions as a news source, for individuals, various media distributors, governments and corporations.

While the present invention has been described in connection with a number of embodiments and implementations, the present invention is not so limited but covers various obvious modifications and equivalent arrangements, which fall within the purview of the appended claims.

What is claimed is:

1. A method, performed by a computer system of a first mobile unit, for displaying images captured by another mobile unit and for capturing images from a camera mounted on the first mobile, comprising:
capturing a plurality of images at a plurality of different locations;
generating a representation of the location where each image was captured;
storing the captured images on storage within the mobile unit;
providing identities of the images in storage and a correlation to the representation of the location where each image was captured; and
transmitting the availability of the stored images, a first mobile unit identification and the representation of the location where each image was captured, by wireless communication.

2. The method of claim 1, further comprising;
storing a representation of the direction of the camera that captured each image.

3. The method of claim 1, further comprising;
storing a representation of the speed of the first mobile unit when it captured each image.

4. The method of claim 1, further comprising:
in response to a command from a service center for a stored image, extracting the requested image from storage and transmitting the requested image by wireless communication to a requestor other than the service center.

5. The method of claim 1, wherein:
said transmitting is to a central service center and identifies a destination for the image, which destination is other than the service center.

6. A method, performed by a computer system at a service center, for administering capturing of images by a plurality of cameras mounted on mobile units and for administering displaying of the images, comprising:
providing a database with identities of the mobile units;
receiving a request from a requestor for an image captured at a location; and
transmitting, by wireless communication, the request to one of the mobile units that is not the requestor.

7. The method of claim 6, further comprising:
generating the request of said transmitting step to include identification of the requester, to be used by the one of the mobile units as a destination address for direct wireless transmission of the image from the one of the mobile units to the requestor.

8. The method of claim 6, further comprising
providing a database correlation between identities of images, representations of the location where the images were captured and identities of the mobile units that captured and currently store the images;
extracting image availability from the database in response to the request;
when the image is available, said step of transmitting comprising a command to the one of the mobile units to remove the image from storage in the mobile unit and transmit the image to the service center; and
upon receipt of the image from the one of the mobile units, re-transmitting the image to the requester.

9. The method of claim 6, further comprising
providing a database correlation between identities of images, representations of the location where the images were captured and identities of the mobile units that captured and currently store the images;
extracting image availability from the database in response to the request;
when the image is not available, extracting the identity of a vehicle near the location and generating the request of said step of transmitting to include a command to the one of the mobile units to capture the image and transmit the image directly to the service center; and
upon receipt of the image from the one of the mobile units, retransmitting the image to the requestor.

10. The method of claim 6, further comprising
providing a database correlation between current locations of the mobile units, identities of images, representations of the location where the images were captured and identities of the mobile units that captured and currently store the images;
extracting image availability from the database in response to the request; and
when the image is not available, extracting the identity of a vehicle near the location and generating the request of said step of transmitting to include a command to the one of the mobile units to capture the image and transmit the image directly to the requester.

11. A method, performed by a computer system, for displaying images captured from a camera mounted on mobile units having a location sensor, comprising:
providing identities of the images;
displaying a map on a display;
displaying an icon on the map for each of at least some of the images;
correlating the icons to respective identities of the images; and
positioning each of the icons on the display screen at a location corresponding to the location of the mobile unit at the time that the corresponding mobile unit captured the image.

12. The method of claim 11, further comprising:
providing the icons as arrows; and
pointing each of the arrows in a direction related to a direction of image capture.

13. The method of claim 12, wherein
said pointing points the arrows in the moving direction of the mobile units that captured the image.

14. The method of claim 12, wherein
said pointing points the arrows in the direction of the camera that captured the image.

15. The method of claim 12, further comprising:
relating lengths of the arrows respectively to speeds of the mobile units that captured the corresponding images.

16. The method of claim 11, further comprising:
selecting an image for display on the display with a curser and one of the icons.

17. The method of claim 16, further comprising:
providing a directory of the identities of the images, the locations of respective capture of the images, and the icons; and
in response to said selecting, searching the directory and transmitting a request for the selected image according to results of said searching.

18. The method of claim 17, wherein:
said transmitting identifies a destination for the request as a central service center.

19. The method of claim 11, further comprising:
performing said method with a mobile unit;
receiving a request for an image by wireless transmission directly from a different mobile unit;
capturing and storing a plurality of video images;
providing a directory of the identities of the captured images, the locations of respective capture of the images; and
in response to said request, searching the directory and transmitting an image that corresponds to the request according to results of said searching.

20. The method of claim 10, further comprising:
providing a directory of the identities of the images, the locations of different mobile units at the time that the different mobile units respectively captured the images, and the icons.

21. A method of managing data, comprising:
receiving current environmental data by wireless transmission from a plurality of mobile units equipped with environment data collecting sensors;
identifying the location area of the mobile units;
generating data density representations related to current data quantity per different location areas; and
limiting current data density to at or below a set amount.

22. The method of claim 21, wherein
said limiting includes sending a suspend transmission signal to only selected ones of the mobile units within an area wherein the received data density exceeds the set amount.

23. The method of claim 21, wherein
said limiting includes sending a suspend transmission signal defining a location area wherein the suspend transmission signal is valid.

24. The method of claim 21, wherein
said limiting includes sending a suspend transmission signal defining a time period wherein the suspend transmission signal is valid.

25. The method of claim 21, wherein
said limiting includes selectively discarding current data from the location area wherein the received data density exceeds the set amount.

26. A navigation method for a motor vehicle, comprising:
receiving information generated from both an image captured by a camera onboard another motor vehicle and from the location of the another vehicle when the image was captured;
showing the information together with a plurality of route information on a display screen;
receiving a user's selection of one of the information shown; and
showing navigation information of the route in response to the selection received.

27. A method for displaying image data:
receiving image data with location information of where the image data was captured and movement direction information of a vehicle mounting a camera that captured the image when the image data was taken; and
displaying together a representation of the image data, the location information and movement direction information.

28. The method of claim 27, wherein
said displaying is superimposed on a map display that includes the location of the location information.
